(19) United States
(12) Patent Application Publication
(10) Pub. No.: US 2010/0082869 A1
(43) Pub. Date: Apr. 1, 2010

(54) STACKABLE I/O MODULES APPEARING AS STANDARD USB MASS STORAGE DEVICES

(75) Inventors: Robert F. Lloyd, Muskego, WI (US); Daniel V. Lang, Elk Grove Village, IL (US)

Correspondence Address: Susan M. Donahue;Rockwell Automation, Inc./FY, 1201 South Second Street, E-7F19, Milwaukee, WI, 53204, US

(73) Assignee: ROCKWELL AUTOMATION TECHNOLOGIES, INC., Mayfield Heights, OH (US)

(21) Appl. No.: 12/239,299

(22) Filed: Sep. 26, 2008

(51) Int. Cl. G06F 13/00

(52) U.S. Cl. 710/305

(57) ABSTRACT

An industrial automation device is provided that includes a universal serial bus interface and an I/O module coupled to the industrial automation device via the universal serial bus interface, wherein the I/O module is configured to connect as one of a plurality of universal serial bus device classes. An I/O module is provided that includes a plurality of inputs, a plurality of outputs, a universal serial bus connection configured to couple to the industrial automation device, a memory configured to store one of a plurality of universal serial bus device class information. A method for connecting the I/O module to the industrial automation device is also provided.

### BACKGROUND

The invention relates generally to the field of industrial control systems, such as those used in industrial and commercial settings. More particularly, embodiments of the present invention relate to techniques for accessing, configuring, and interfacing with configurable I/O modules coupled to an industrial controller.

Industrial controllers are special purpose computers used for controlling factory automation and the like. Under the direction of stored programs, a processor of the industrial controller examines a series of inputs reflecting the status of a controlled process and changes outputs affecting control of the controlled process. The stored control programs may be is continuously executed in a series of execution cycles, executed periodically, or executed based on events.

The inputs received by the industrial controller from the controlled process and the outputs transmitted by the industrial controller to the controlled process are normally passed through one or more input/output (I/O) modules, which serve as an electrical interface between the controller and the controlled process. The inputs and outputs are recorded in an I/O data table in memory. Input values may be asynchronously read from the controlled process by specialized circuitry. Output values are written directly to the I/O data table by the processor, then communicated to the controlled process by the specialized communications circuitry.

Some industrial controllers may provide for connection of additional I/O modules to add input and output functionality to the controller. For example, adding an I/O module may allow the industrial controller to interface with a specific type of control equipment. The I/O modules often require use of non-standard hardware interfaces. Although some I/O modules may use standard hardware interfaces, such as a universal serial bus (USB) interface, these standard interfaces may not provide a device class for an I/O module. These I/O modules still require custom drivers and other custom software to allow their use with a controller. Additionally, providing use of the I/O modules across multiple controller types and platforms, adds further challenges, as the different controllers and platforms may use different processors and operating systems. Porting the customer drivers and other software to each controller type and platform may add complexity, cost, and development time.

### BRIEF DESCRIPTION

The present invention provides a novel approach to connecting and using I/O modules with a control/monitoring device for controlling or monitoring an industrial process. The I/O modules may be connected to the control/monitoring device via an interface, such as a USB interface, and the I/O module may be configured to connect as one of a plurality of universal serial bus device classes. The I/O modules may include a plurality of inputs and outputs, a USB interface, and a memory configured to store USB device class information.

Methods and devices are all supported for performing these and other functions of the invention.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an exemplary control and monitoring system including a human-machine interface (HMI) adapted to interface with networked components and configuration equipment in accordance with embodiments of the present techniques;

FIG. 2 is a block diagram illustrating components of the control/monitoring device of FIG. 1 according to an embodiment of the present invention;

FIG. 3 depicts screens or windows of the control/monitoring device or HMI of FIG. 1 showing connection of an I/O module in accordance with an embodiment of the present invention;

FIG. 4 depicts screens or windows of the control/monitoring device or HMI of FIG. 1 showing connection of multiple I/O modules in accordance with an embodiment of the present invention; and

FIG. 5 depicts a process 300 for connecting and recognizing an I/O module coupled to the control/monitoring device in accordance with an embodiment of the present invention.

### DETAILED DESCRIPTION

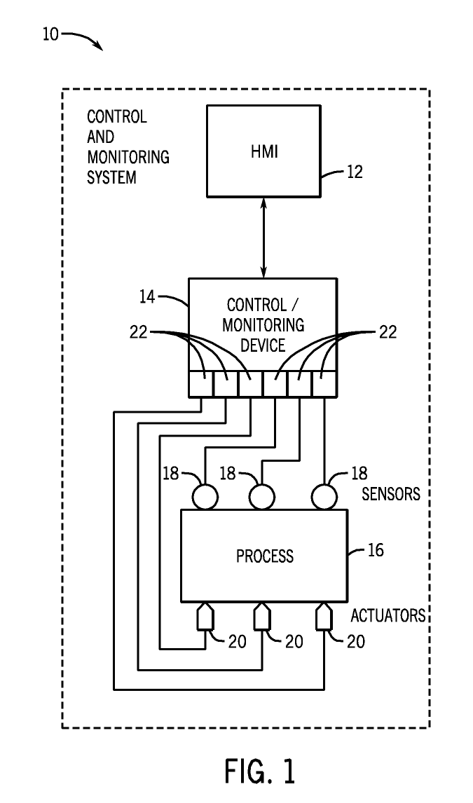

FIG. 1 is a diagrammatical representation of an exemplary control and monitoring system including an HMI adapted to interface with networked components and configuration equipment in accordance with embodiments of the present techniques. The control and monitoring system may generally be referred to by reference numeral 10. Specifically, the control and monitoring system 10 is illustrated as including an HMI 12 and a control/monitoring device 14 adapted to interface with components of a process 16. It should be noted that such an interface in accordance with embodiments of the present techniques may be facilitated by the use of certain network strategies. Indeed, an industry standard network may be employed, such as DeviceNet, to enable data transfer. Such networks permit the exchange of data in accordance with a predefined protocol, and may provide power for operation of networked elements.

The process 14 may take many forms and include devices for accomplishing many different and varied purposes. For example, the process may comprise a compressor station, an oil refinery, a batch operation for making food items, a mechanized assembly line, and so forth. Accordingly, the process 14 may comprise a variety of operational components, such as electric motors, valves, actuators, temperature elements, pressure sensors, or a myriad of manufacturing, processing, material handling and other applications. Further, the process 14 may comprise control and monitoring equipment for regulating process variables through automation and/or observation. For example, the illustrated process 14 comprises sensors 18 and actuators 20. The sensors 18 may comprise any number of devices adapted to provide information regarding process conditions. The actuators 20 may include any number of devices adapted to perform a mechanical action in response to an input signal.

As illustrated, these sensors 18 and actuators 20 are in communication with the control/monitoring device 14 (e.g., a programmable logic controller) and may be assigned a particular address in the control/monitoring device 14 that is accessible by the HMI 12. In one embodiment, the sensors 18 and actuators 20 may communicate with the control/monitoring device 14 via one or more I/O modules 22 coupled to the control/monitoring device 14. The I/O modules 22 may transfer input and output signals between the control/monitoring device 14 and the controlled process 14.

These devices (sensors 18 and actuators 20) may be utilized in accordance with embodiments of the present techniques to operate process equipment. Indeed, they may be utilized within process loops that are monitored and controlled by the control/monitoring device 14 and/or the HMI 12. Such a process loop may be activated based on process inputs (e.g., input from a sensor 18) or direct operator input received through the HMI 12.

The I/O modules 22 may be integrated with the control/monitoring device 14, or may be added or removed via expansion slots, bays or other suitable mechanism. For example, to add functionality to the control/monitoring device 14, additional I/O modules 22 may be added, such as if new sensors 18 or actuators 20 or added to control the process 16. These I/O modules serve as an electrical interface to the controller and may be located proximate or remote from the controller including remote network interfaces to associated systems.

The I/O modules 22 may include input modules that receive signals from input devices such as photo-sensors and proximity switches, output modules that use output signals to energize relays or to start motors, and bidirectional I/O modules, such as motion control modules which can direct motion devices and receive position or speed feedback. In some embodiments, the I/O modules 22 may convert between AC and DC analog signals used by devices on a controlled machine or process and +5-volt DC logic signals used by the controller. Additionally, some of the I/O modules 22 may provide digital signals to digital I/O devices and received digital signals from digital I/O devices. Further, in some embodiments, the I/O modules 22 that are used to control motion devices or process control devices may include local microcomputing capability on the I/O module.

In some embodiments, the I/O modules 22 may thus be located in close proximity to a portion of the control equipment, and away from the remainder of the controller. Data is communicated with remote modules over a common communication link, or network, wherein modules on the network communicate via a standard communications protocol. Many industrial controllers can communicate via network technologies such as Ethernet (e.g., IEEE802.3, TCP/IP, UDP, EtherNet/IP, and so forth), ControlNet, DeviceNet. or other network protocols (Foundation Fieldbus (Hi and Fast Ethernet) Modbus TCP, Profibus) and also communicate to higher level computing systems.

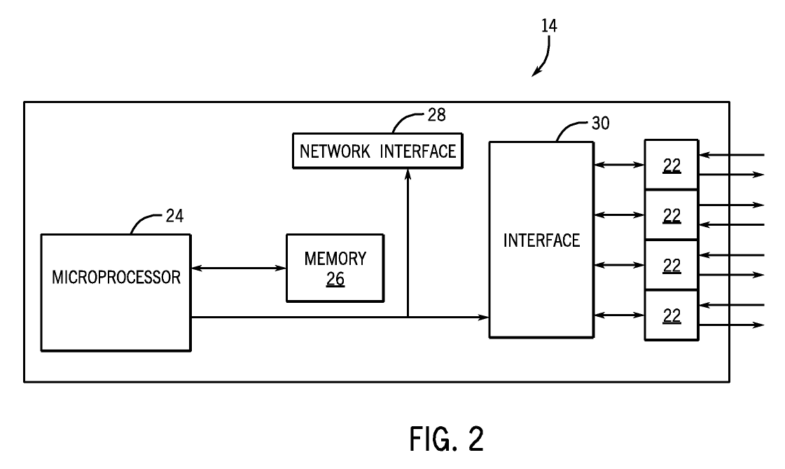

FIG. 2 is a block diagram illustrating components of the control/monitoring device 14 according to an embodiment of the present invention. The device 14 may include a microprocessor 24 that may read and write to a memory 26. The memory 26 holds programs executed by the microprocessor 24 to provide desired functions and also variables and data necessary for the execution of those programs.

The device 14 may also include a network interface 28 to provide for communication over the networks described above. To facilitate connection and communication with the I/O modules 22, the device 14 may include an interface 30. The interface 30 may be a serial or parallel interface, and may provide connection to the I/O modules via plugs, slots, or any other suitable connector. In one embodiment, the interface 30 may comprise a universal serial bus interface. In such an embodiment, the I/O modules 22 may connect to the device 14 via a standard USB plug, such as A-type or B-type. In other embodiments, the I/O modules 22 may use a proprietary/non-standard USB connector to connect to the device 14.

Input data is collected from the I/O modules 22 and communicated to the controller processor. The controller processor performs logic operations on the input data to produce output. Inputs and outputs may be recorded in the processor memory 26, wherein input values may be asynchronously read from one or more I/O modules and output values written to the memory 26 for subsequent communication to the control system by specialized communications circuitry (e.g., back plane interface, communications module). The I/O modules 22 may interface directly with one or more control elements, by receiving an output from the I/O table to control a device such as a motor, valve, solenoid, amplifier, and the like.

In an embodiment using a USB interface as the interface 30 of the device 22, the I/O modules 22 may be recognized as one of a USB device class. Advantageously, because interfacing with such device classes are defined according the USB standard, recognizing the I/O modules 22 as belonging to a USB device class does not require any custom device driver or other custom software to ensure operability of the device. For example, in on embodiment, the I/O modules may be recognized as a USB Mass Storage device, i.e. as a Mass Storage device class. In other embodiments, the I/O modules 22 may be recognized as a Human Interface device, or any other suitable device class.

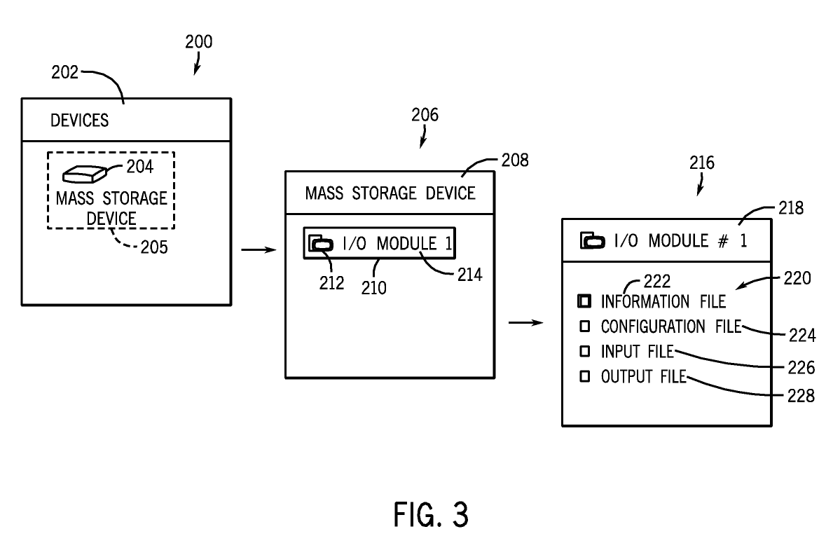

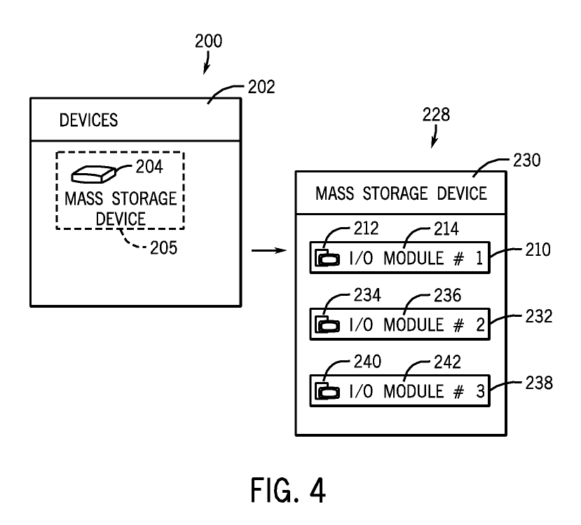

FIGS. 3 and 4 depict display screens of the control/monitoring device 14, or the HMI 12 coupled to the device, that illustrate recognition of the I/O modules 22 as a USB Mass Storage device according to an embodiment of the present invention. As illustrated in FIG. 3, a first screen or window 200 may include a title bar 202 indicating that a user is viewing a list of devices. For example, in FIG. 3 the title bar 202 may include the text “DEVICE” to indicate that the control/monitoring device 14 or HMI 12 is displaying the list of devices connected to the control/monitoring device 14. In the screen or window 200, one or more I/O modules 22 may be displayed as an icon 204 indicating connection as a USB Mass Storage device 205.

To select further detail about the I/O modules, a user may select the USB Mass Storage device 205, thereby opening another screen or window 206. In some embodiments, the second screen or window 206 may replace the first screen or window 200, or may display in addition to the first screen or window 200. The second screen or window 206 may include a title bar 208 that indicates the device being viewed, and includes the text “MASS STORAGE DEVICE” to indicate that the Mass Storage Device 205 is selected. In one embodiment, an I/O module 22 may be displayed as a folder 210 of the Mass Storage device 205. For example, the folder 210 may display as an icon 212 and a corresponding text 214 (“I/O Module 1”) indicating a name or identifier of the I/O module 22 represented by the folder 210.

To further configure or view details of an I/O module 22, a user may select the folder 210, thereby opening a third screen or window 216. The third screen or window 216 may replace the second screen or window 206, or may display in addition to the second screen or window 206. The third screen or window 216 may include a title bar 218 that indicates the folder being viewed, and includes the text “I/O Module I” to indicate that the folder 210 corresponding to I/O Module I is selected. In an embodiment, an I/O module may include virtual files corresponding to various information and data of the I/O module 22. By representing the information and data as virtual files, the control/monitoring device 14 or HMI 12 may display such information or data as files of the folder 210 of the Mass Storage device.

In the embodiment depicted in FIG. 3, the screen or window 216 shows four files 220 of the Mass Storage device, corresponding to data of the I/O module 22. The files 220 may include an information file 222, a configuration file 224, an input file 226, and an output file 228. The information file 222 may include identification information about the I/O module 22, and may be used by the control/monitoring device 14 to identify the I/O module 22. The configuration file 224 may by used to configure the I/O module 22, such as setting up and adjusting operational parameters. For example, a user of the control/monitoring device 14 and/or HMI 12 may edit the configuration file 224 to configure the I/O module 22. The input file 226 may read the physical inputs of the I/O module 22, and a user may view the input file 226 to view the physical inputs. Similarly, the output file 226 may write the physical outputs of the I/O module 22.

In other embodiments, a user, the control/monitoring device 14, or the HMI 12 may add physical data files to the folder 210, and thus to the I/O module 210 corresponding to the folder 210. For example, a data file containing user documentation describing the process and signals of the I/O module may be added. Additionally, data files that contain maintenance records, input and output history, resource usage history, or other suitable files may be added.

FIG. 4 depicts screen or windows displaying multiple I/O modules 22 connected to the control/monitoring device 14. As stated above, in one embodiment a first screen 200 may include the title bar 202 and an icon 204. The icon corresponds to the USB Mass Storage device. If a user desires to view the I/O modules 22 connected to the control/monitoring device 22, a user may select the icon corresponding to the Mass Storage device, thereby prompting display of a second screen or window 228. The second screen or window 228 may replace the first screen or window 200, or may be displayed in addition to the first screen or window 200. The second screen or window 228 may include a title bar 230 that indicates the device being viewed, such as by displaying the text “Mass Storage Device.” As illustrated in the second screen or window 228, each individual I/O module 22 is displayed as a separate folder of the Mass Storage Device. For example, a first I/O module may be displayed as folder 210, and may include a corresponding icon 212 and text 214 (“I/O Module #1”). A second I/O module may be represented as folder 232, displayed as an icon 234 and text 236 (“I/O Module #2.”) A third I/O module may be represented as third folder 238, displayed as an icon 240 and text 242 (“I/O Module #3”).

To view data of each I/O module, a user may select the corresponding folder 210, 232, or 238, and open a screen or window displaying the virtual files for each, as discussed above. In other embodiment, each I/O module 22 may be displayed as a separate Mass Storage device, or may be displayed as a different USB device class. In such an embodiment, the I/O modules may not display virtual files, but may use other virtualized objects appropriate to the particular USB device class.

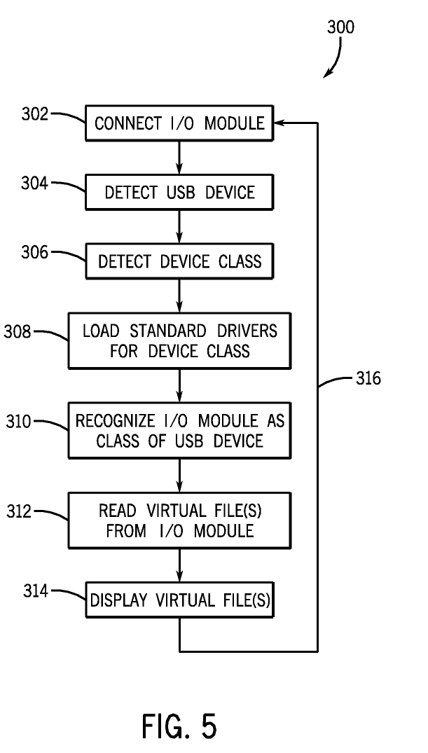

FIG. 5 depicts a process 300 for connecting and recognizing any I/O modules 22 coupled to USB interface of the control/monitoring device 14 in accordance with an embodiment of the present invention. A user or technician may connect an I/O module 22 to the control/monitoring device 14 (block 302), such as by the USB connectors described above. To detect connection of an I/O module 22, the control/monitoring device 14 may continuously poll the USB port or connection and may detect the I/O module after it is connected (block 304). Once the I/O module is connected, the control/monitoring device may detect the device class of the I/O module, such as by sending various signals to the I/O module and receiving a response (block 306).

Once the particular device class is determined, the control/monitoring device 14 may load the standard drivers for the device class (block 308) and recognize the I/O module as a particular class of device (block 310). For example, as stated above, if the I/O module is recognized as a USB Mass Storage device, the control/monitoring device 14 will load the standard device drivers for that class. In one embodiment, the control/monitoring device 14 may read one or more virtual files stored on the I/O module 22 (block 312), as described above, that correspond to data about the I/O module 22. The control/monitoring device 14 may display the virtual files (block 314), either directly on the HMI 12 coupled to the control/monitoring device 14. If a user adds additional I/O modules 22 to the control/monitoring device 14, these modules may be connected and recognized by the same process 300 (line 316).

While only certain features of the invention have been illustrated and described herein, many modifications and changes will occur to those skilled in the art. It is, therefore, to be understood that the appended claims are intended to cover all such modifications and changes as fall within the true spirit of the invention.

1. An industrial automation device, comprising:
a universal serial bus interface; and
an I/O module coupled to the industrial automation device via the universal serial bus interface, wherein the I/O module is configured to connect as one of a plurality of universal serial bus device classes.

2. The device of claim 1, wherein the I/O module is configured to convert analog signals to digital signals, provide digital signals, receive digital signals, receive analog signals, perform computations, or any combination thereof.

3. The device of claim 1, wherein the I/O module is recognized as universal serial bus mass storage device class, wherein the I/O module is further recognized as a directory of the universal serial bus mass storage device.

4. The device of claim 3, wherein the I/O module comprises a memory.

5. The device of claim 3, wherein the memory is configured to store a unique identifier, configuration data, input data, and output data.

6. The device of claim 3, wherein the memory is configured to store data as a plurality of virtual files, wherein the plurality of virtual files comprise an a information file, a configuration file, an input file, and an output file.

7. The device of claim 5, comprising a human machine interface configured to display data stores in the memory as a plurality of virtual files, wherein the plurality of virtual files comprise an a information file, a configuration file, an input file, and an output file.

8. The device of claim 1, comprising a second I/O module, wherein the second I/O module is configured to be recognizes as the one of the universal serial bus class.

9. The method of claim 2, wherein the second I/O module is configured to be recognized as second folder of the universal serial bus mass storage device.

10. An I/O module for an industrial automation device, comprising:
a plurality of inputs;
a plurality of outputs;
a universal serial bus connection configured to couple to the industrial automation device; and
a memory configured to store one of a plurality of universal serial bus device class information.

11. The I/O module of claim 10, comprising a memory configured to store virtual files representing a unique identifier, a configuration, a physical input, a physical output, or a combination thereof, of the I/O module.

12. A method for connecting an I/O module to an industrial automation device, comprising:
detecting an I/O module; and
recognizing the I/O module as a one of a plurality of universal serial bus device classes.

13. The method of claim 12, recognizing the I/O module as a universal serial bus mass storage device.

14. The method of claim 13, comprising displaying the I/O module as a directory of the universal serial bus mass storage device.

15. The method of claim 12, comprising recognizing a second I/O module as the one of plurality of universal serial bus device classes.

16. The method of claim 15 comprising recognizing the second I/O module as a universal serial bus mass storage device.

17. The method of claim 16, comprising displaying the second I/O module as a second directory of the universal serial bus mass storage device.

18. The method of claim 12, comprising displaying a plurality of files in the directory, wherein the files represent a unique identifier, a configuration, a physical input, a physical output, or a combination thereof, of the I/O module.

19. The method of claim 12, comprising adding a file to the directory, wherein the file comprises a maintenance record of the I/O module.

20. The method of claim 12, comprising adding a file to the directory, wherein the file comprises a user documentation of the I/O module.
